(19) United States
(12) Patent Application Publication
(10) Pub. No.: US 2026/0126550 A1
(43) Pub. Date: May 7, 2026

(54) UNKNOWN ENVIRONMENT MAPPING METHOD FOR SINGLE-BEAM LASER OF AIRCRAFT

(71) Applicants: Southwest University of Science and Technology, Mianyang (CN); Harbin Institute of Technology, Harbin (CN)

(72) Inventors: Jianwen HUO, Mianyang (CN); Ping ZHANG, Mianyang (CN); Jingnan PENG, Mianyang (CN); Lihui ZHANG, Mianyang (CN); Liguo TAN, Harbin (CN); Mingrun LING, Mianyang (CN); Hua ZHANG, Mianyang (CN); Jun SUN, Mianyang (CN)

(73) Assignees: Southwest University of Science and Technology, Mianyang (CN); Harbin Institute of Technology, Harbin (CN)

(21) Appl. No.: 19/437,754

(22) Filed: Dec. 31, 2025

(30) Foreign Application Priority Data
Feb. 25, 2025 (CN) 202510027218.4

(51) Int. Cl. G01S 17/89; G05D 1/24; G05D 1/49; G05D 1/644; G05D 105/80; G05D 109/20; G05D 111/10; G06V 10/22; G06V 10/30; G06V 10/762; G06V 10/80; G06V 20/17

(52) U.S. Cl. CPC G01S 17/89; G05D 1/24; G05D 1/49; G05D 1/644; G06V 10/23; G06V 10/30; G06V 10/762; G06V 10/806; G06V 20/17; G05D 2105/87; G05D 2109/20; G05D 2111/17

(57) ABSTRACT

The invention discloses an unknown environment mapping method for a single-beam laser of aircraft, which belongs to the field of three-dimensional map reconstruction technology. Firstly, the data collected by a single-beam LiDAR is aligned with the timestamp of the stepper motor, and the obtained point cloud data is filtered and matched to obtain three-dimensional map information. The pose of the aircraft is estimated by the wheel odometer and IMU, and the loop detection is performed to reduce the cumulative error and update the three-dimensional map information in real time. The frontier search algorithm is used to determine the target point of the aircraft flight, the A* algorithm is used to plan the path trajectory, and the B-spline curve optimization algorithm is used to make the trajectory of the aircraft smoother. The control command is sent to the aircraft, and then the global three-dimensional map of the unknown environment is obtained.

### TECHNICAL FIELD

The invention belongs to the field of autonomous navigation robots and LiDAR three-dimensional space reconstruction technology, and specifically relates to an unknown environment mapping method for a single-beam laser of aircraft.

### BACKGROUND

Traditional surveying and mapping methods mainly rely on manual measurements conducted by surveying engineers. However, the measurement process is cumbersome, time-consuming, and wastes considerable manpower and material resources. Moreover, the outcome of such measurements is often less than ideal, with errors that are difficult to control, resulting in relatively low accuracy. With the advancement of 3D spatial reconstruction technology, surveying personnel now only need to traverse the environment to be mapped using equipment equipped with surveying tools. This allows environmental structure information to be acquired more easily, greatly reducing errors caused by manual measurement. Three-dimensional reconstruction technology serves as an important technical means for aircraft to perceive their surrounding environment. By utilizing various sensors onboard, the aircraft can actively capture characteristic information from its surroundings. However, multi-beam LiDAR, which offers better mapping performance on the market, is expensive and may not be cost-effective in certain environmental measurement scenarios.

To overcome the drawbacks of traditional single-beam LiDAR 3D reconstruction methods and to enhance portability, measurement accuracy, and cost-effectiveness, the invention patent designs a single-beam laser-based mapping system for unknown environments. This system primarily uses a single-beam radar to accomplish 3D environmental reconstruction. It retains the advantages of multi-beam radar, such as long measurement range, insensitivity to light intensity and weather conditions, and the ability to obtain high-precision three-dimensional environmental information.

### SUMMARY

In view of the above shortcomings in the existing technology, an unknown environment mapping method for a single-beam laser of aircraft provided by the invention solves the problems of insufficient measurement accuracy, poor portability, and economy of the existing related methods. It employs a single-beam laser to perform a three-dimensional environmental reconstruction, while retaining the advantages typical of multi-beam radar, such as an extensive measurement range, immunity to variations in light intensity and weather conditions, and the capability to acquire highly accurate three-dimensional environmental data.

In order to achieve the above invention purpose, the technical scheme adopted in this invention is: An unknown environment mapping method for a single-beam laser of aircraft, the aircraft is configured with a single-beam LiDAR, a stepper motor, and a binocular camera, and point cloud data of the single-beam LiDAR is aligned with stepper motor data on a timestamp.

The method includes the following steps:
S1, denoising point cloud data collected at a current position, and adjusting position and attitude information of an aircraft by using denoised point cloud data, so as to unify a single-beam LiDAR coordinate system and the aircraft;
S2, based on a unified coordinate system, aligning the point cloud data at adjacent positions initially, and performing a feature extraction, a point cloud alignment and a point cloud stitching in turn to generate a unified point cloud map;
S3, for point cloud data in the unified point cloud map, establishing a local neighborhood of each point cloud according to a K-nearest neighbors search algorithm, and determining a local tangent space of each point cloud in a local neighborhood by a principal component analysis method, using a multi-dimensional scaling analysis method to integrate information of all local tangent spaces, and obtaining a global parameterization of the point cloud data on a Riemannian manifold;
S4, based on point cloud data represented by the global parameterization, generating a continuous three-dimensional manifold surface according to a Delaunay triangulation method, and generating a local map of the current position after a smooth and curvature adjustment of the continuous three-dimensional manifold surface;
S5, in a process of aircraft data acquisition, using a loop detection algorithm to correct a pose of the aircraft, and then optimizing a local map to obtain an optimized local map;
S6, taking a current optimized local map as a starting point, performing a boundary exploration and a path planning, and collecting data according to a planned path, repeating S1-S5 to gradually generate an optimized local map, and then completing an unknown environment mapping.

In some embodiments, S1 includes the following steps:
S11, calculating a distance between the point cloud data collected at the current position and its adjacent point cloud;
S12, according to an average value and standard deviation of each distance, determining a determination threshold of an outlier point cloud;
S13, removing outlier point cloud data according to the determination threshold of the outlier point cloud, and completing a point cloud noise reduction;
S14, extracting feature points from the point cloud data after a noise reduction;
S15, according to a type of feature points and a nearest point search method, establishing a geometric relationship between feature points after noise reduction at different times, and then calculating a pose estimation of a single-beam LiDAR during this period;
S16, according to an estimated pose estimation, using the point cloud data from different perspectives for three-dimensional reconstruction, and then determining an initial pose of the aircraft;
S17, according to the initial pose of the aircraft, using a Kalman-based fusion matching algorithm to predict a next state estimation of the aircraft, and correcting the state estimation according to a difference between a predicted value and an actual observed value to obtain a next pose of the aircraft;
S18, weighting and averaging the initial pose and the next pose of the aircraft to adjust the attitude information of the aircraft, and then unifying a single-beam LiDAR coordinate system of the aircraft.

In some embodiments, S2 includes the following steps:
S21, according to a random sampling consistency algorithm, using a registration point to unify a coordinate system of two points to be configured in the point cloud data at adjacent positions, and completing an initial alignment to obtain coarsely calibrated point cloud data;
S22, clustering continuous point cloud data collected by a single-beam LiDAR to extract feature points;
types of feature points include scatter points, corner points, and breakpoints;
S23, using an improved iterative adaptive point algorithm to screen the corner points, using a continuous edge tracking algorithm to screen the breakpoints, and then screening out all the real corner points and breakpoints, and filtering out scattered points;
S24, using a least square method to perform a feature line fitting of selected corner points and breakpoints to determine a feature line segment;
S25, using an ICP algorithm to coarsely calibrate point cloud data and feature line segments for fine registration;
S26, fusing finely registered point cloud data into a unified voxel grid, and performing a point cloud stitching to generate a unified point cloud map.

In some embodiments, in S22, the method of clustering continuous point cloud data is as follows:
Taking a position of a single-beam LiDAR as an origin O, scanning a straight line L representing a detected object at an equal interval angle Δθ, and then obtaining a continuous point cloud data Qᵢ; a length distance between the origin and each point cloud data is expressed as dᵢ, and then calculating a slope value of an i-th point cloud data; when a slope value difference between adjacent point cloud data is less than a predetermined threshold, it is determined to be on the same straight line; otherwise, it is determined to be a mutation point and used as a feature point;
where a slope value kᵢ is expressed as:

$${k}_{i} = \frac{{d}_{i + 1} - {d}_{i}}{{d}_{i} Δ θ} .$$

In some embodiments, S3 includes the following steps:
S31, using the K-nearest neighbors search algorithm to search each point cloud in the point cloud data of the unified point cloud map to find a corresponding K-nearest neighbors point cloud;
S32, using a principal component analysis network to perform a principal component analysis on a neighborhood of a searched point cloud, calculating a covariance matrix and extracting eigenvalues and eigenvectors, and then obtaining a local tangent space of each point cloud in a corresponding neighborhood;
S33, calculating a Riemannian metric matrix of each point cloud according to the local tangent space;
S34, using a multidimensional scale analysis method to integrate the Riemannian metric matrix of all point clouds to obtain a global parameter representation of point cloud data on the Riemannian manifold.

In some embodiments, the S32 is specified as follows:
Using a principal component analysis network to perform a principal component analysis on the neighborhood of the point cloud obtained by searching; decentralizing point cloud data obtained by analysis, and calculating a covariance matrix of decentralized neighborhood point cloud data; decomposing the covariance matrix to obtain the eigenvalues and eigenvectors, and calculating the local tangent space of each point cloud in its field according to the eigenvalues and eigenvectors;
in a three-dimensional space where the local tangent space is located, a feature vector Vⱼ corresponds to a main direction of a local geometry, where a feature vector V₁ denotes a main direction of a point cloud data distribution, a feature vector V₂ denotes a secondary direction, and a feature vector V₃ denotes a local normal vector, that is, a normal vector of the point cloud surface; the feature vectors V₁ and V₂ form the local tangent space, and the feature vector V₃ is perpendicular to the local tangent space.

In some embodiments, S4 includes the following steps:
S41, using the Delaunay triangulation method to generate a triangular mesh in a manifold space where globally parameterized point cloud data is located, and generating a continuous three-dimensional manifold surface from the triangular mesh;
S42, extracting a topological structure of the three-dimensional manifold surface;
S43, extracting topological structure characteristics of the three-dimensional manifold surface by using a discrete Morse theory algorithm, and optimizing the topological structure;
S44, using an optimization method of graph cuts to perform a smooth and curvature adjustment for the three-dimensional manifold surface according to an optimized topology;
S45, performing a three-dimensional visualization of the three-dimensional manifold surface after the smooth and curvature adjustment to generate a local map of a current position.

In some embodiments, S5 includes the following steps:
S51, in a process of local map generation, collecting aircraft odometer data continuously to obtain real-time estimated pose information and determine a corresponding current position;
S52, when an Euclidean distance between the current position and a historical position of the aircraft is less than the predetermined threshold, a loopback detection is triggered;
S53, extracting feature points from collected data of a binocular camera configured for the aircraft;
S54, performing a feature point matching and data splicing on extracted feature points in turn, and then fusing with the point cloud data of a LiDAR in the current position;
S55, according to fused data, calculating a pose error of the aircraft between a current frame and a historical frame, and according to aircraft pose information after optimization and adjustment, and then fusing the point cloud data corresponding to the optimized aircraft pose information into the local map;
S56, performing a smooth and curvature adjustment of the three-dimensional manifold surface corresponding to the local map after a fusion of point cloud data to obtain an optimized local map.

In some embodiments, S6 includes the following steps:
S61, detecting a boundary of an unexplored area in the current optimized local map, and selecting a target point closest to the aircraft;
S62, using an A* path planning algorithm to calculate an optimal path from a current boundary point to the target point;
S63, performing a uniform sampling for the determined optimal path, using selected control points, curve orders, and node vectors to calculate a B-spline basis function, and then subdividing a B-spline curve into several discrete points as passing points of the aircraft;
S64, performing S1-S5 to gradually generate an optimized local map at each passing point, and then completing an unknown environment mapping.

In some embodiments, in S63, under a selected set of control points {p₀, p₁, . . . , p_{N}}, the B-spline curve is represented as:

$$C ( t ) = {\sum }_{n = 0}^{N} {N}_{n , k} ( t ) {P}_{n} .$$

where C(t) denotes a point of the B-spline curve at a parameter t, Pₙ denotes an n-th control point, and N_{n,k}(t) denotes a k-th-order B-spline basis function corresponding to an n-th control point, it is expressed as:

$${N}_{nk} ( t ) = \frac{t - {t}_{n}}{{t}_{n + k} - {t}_{n}} {N}_{n , k - 1} ( t ) + \frac{{t}_{n + k + 1} - t}{{t}_{n + k + 1} - {t}_{n + 1}} {N}_{n + 1 , k - 1} ( t )$$

where tₙ denotes the n-th node value in the spline knot vector.

The beneficial effects of the invention are as follows:

(1) The method of this invention reduces mapping costs and compensates for the relative lack of point cloud data collected by single-beam LiDAR compared to multi-line LiDAR within a single frame by utilizing time accumulation.

(2) This method introduces improvements at the algorithm level of the mapping process itself, consequently, under identical hardware conditions, it achieves higher mapping accuracy.

(3) By modifying the mapping strategy algorithm, the invention incorporates planned flight paths for the aircraft, this approach not only saves time in spatial search but also ensures mapping accuracy.

### BRIEF DESCRIPTION OF THE DRAWINGS

FIG. 1 is a flow chart of the unknown environment mapping method for the single-beam laser of aircraft in the invention.

### DETAILED DESCRIPTION OF THE EMBODIMENTS

The specific embodiments of the invention are described below to enable those skilled in the art to understand it. Furthermore, it is to be clarified that the invention is not limited to the scope of these specific embodiments. For any person skilled in the art, various modifications that fall within the spirit and scope of the invention as defined and determined by the appended claims are deemed obvious. All inventions conceived based on the inventive concept of the invention are protected.

The embodiment of the invention provides an unknown environment mapping method for a single-beam LiDAR of aircraft, the aircraft is equipped with a single-beam LiDAR, a stepper motor and a binocular camera, and the point cloud data of the single-beam LiDAR and the stepper motor data are aligned on the timestamp; specifically, in this embodiment, the KNN algorithm is used to align the point cloud data of the single-beam LiDAR with the stepper motor data on the timestamp.

In this invention, during the movement of the aircraft, the point cloud data is obtained by a stepper motor equipped with a single-beam LiDAR, the attitude of the aircraft is judged by an odometer and an IMU, and the data fusion under multiple attitudes is completed by point cloud data feature extraction and feature matching. The three-dimensional map is constructed by Riemannian space, and the attitude of the aircraft is corrected by loop detection to optimize the accuracy of map construction. Meanwhile, the path planning trajectory is formed by the frontier search algorithm combined with the A* algorithm to realize the 3D map construction of the single-beam laser unknown environment.

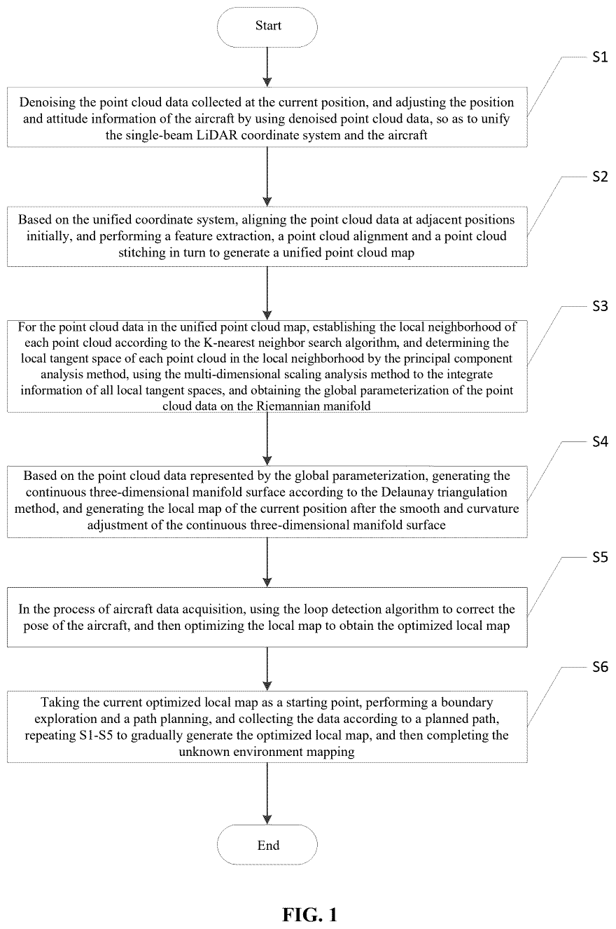

Based on this, as shown in FIG. 1, the unknown environment mapping method for the single-beam laser in the embodiment of the invention includes the following steps:
S1, the point cloud data collected at the current position is denoised, and the denoised point cloud data is used to adjust the pose information of the aircraft, so as to unify the coordinate system of the aircraft and the single-beam LiDAR;
S2, based on the unified coordinate system, the point cloud data at adjacent positions are initially aligned, and feature extraction, point cloud alignment, and point cloud stitching are performed in turn to generate a unified point cloud map;
S3, for the spliced point cloud data, the local neighborhood of each point cloud is established according to the K-nearest neighbors search algorithm, and the principal component analysis method is used to determine the local tangent space of each point cloud in its local neighborhood; the multidimensional scale analysis method is used to integrate the information of all local tangent spaces to obtain the global parameterization of the point cloud data on the Riemannian manifold;
S4, based on the point cloud data represented by global parameterization, a continuous three-dimensional manifold surface is generated according to the Delaunay triangulation method, and a local map of the current position is generated after a smooth and curvature adjustment of the continuous three-dimensional manifold surface;
S5, in the process of aircraft data acquisition, the loop detection algorithm is used to correct the pose of the aircraft, and then the local map is optimized to obtain the optimized local map;
S6, the current optimized local map is taken as the starting point, the boundary exploration and path planning are performed, and the data is collected according to the planned path, S1-S5 are repeated to gradually generate an optimized local map, and then the unknown environment mapping is completed.

S1 of the embodiment of the invention includes the following steps:
S11, the distance between the point cloud data collected at the current position and its adjacent point cloud is calculated;
optionally, the Statistical Outlier Removal algorithm is used to calculate the distance between each point cloud data and its adjacent point cloud.
S12, according to the average value and standard deviation of each distance, the determination threshold of the outlier point cloud is determined;
S13, the outlier point cloud data is removed according to the determination threshold of the outlier point cloud, and the point cloud noise reduction is completed;
S14, the feature points are extracted from the point cloud data after the noise reduction;
S15, according to the type of feature points and the nearest point search method, a geometric relationship between feature points after noise reduction at different times is established, and then a pose estimation of the single-beam LiDAR is calculated during this period;
S16, according to the estimated pose estimation, the point cloud data from different perspectives is used for three-dimensional reconstruction, and then the initial pose of the aircraft is determined;
S17, according to the initial pose of the aircraft, the Kalman-based fusion matching algorithm is used to predict the next state estimation of the aircraft, and the state estimation is corrected according to the difference between the predicted value and the actual observed value to obtain the next pose of the aircraft;
S18, the initial pose and the next pose of the aircraft are weighted and averaged to adjust the attitude information of the aircraft, and then the single-beam LiDAR coordinate system of the aircraft is unified.

Specifically, in this embodiment, the aircraft's attitude estimation process begins with an initialization phase, starting from a static state of the aircraft, and the initial pose is acquired. The system then proceeds to the data acquisition and preprocessing stage, where the acceleration and angular velocity sampled by the IMU are denoised and calibrated to mitigate the influence of sensor noise, the same preprocessing, filtering, and calibration, is applied to odometer data to ensure its accuracy.

In the data fusion stage, the Kalman filter (EKF) fuses the high-frequency, short-term, accurate information from the IMU with the low-frequency, long-term stable information from the odometer through a predict-update cycle. During the prediction step, IMU acceleration and angular velocity data are used to predict the aircraft's pose change via inertial navigation equations. Subsequently, in the update step, the displacement measurement from the odometer is fused to correct the prediction, thereby yielding a more accurate pose estimation.

During specific implementation, the motion model and sensor model of the aircraft are established, the state vector and observation vector are defined, and iterative computation is performed using the Kalman filter's prediction and update formulas. Additionally, a timestamp alignment step is employed to ensure temporal synchronization among sensors, guaranteeing the real-time performance and accuracy of data fusion. Finally, through experimental verification and parameter tuning, the filter parameters are continuously optimized to enhance the robustness and accuracy of the pose estimation.

S2 of the embodiment of the invention includes the following steps:
S21, according to the random sampling consistency algorithm, the registration point is used to unify a coordinate system of two points to be configured in the point cloud data at adjacent positions, and the initial alignment is completed to obtain the coarsely calibrated point cloud data;
S22, the continuous point cloud data collected by the single-beam LiDAR is clustered to extract feature points;
types of feature points include scatter points, corner points, and breakpoints;
S23, the improved iterative adaptive point algorithm is used to screen the corner points, the continuous edge tracking algorithm is used to screen the breakpoints, and then all real corner points and breakpoints are screened out, and the scattered points are filtered out;
S24, the least square method is used to perform a feature line fitting of the selected corner points and breakpoints to determine the feature line segment;
S25, the ICP algorithm is used to coarsely calibrate point cloud data and feature line segments for fine registration;
S26, the finely registered point cloud data is fused into a unified voxel grid, and the point cloud stitching is performed to generate a unified point cloud map.

In S22 of this embodiment, the method of clustering continuous point cloud data is as follows:
the position of the single-beam LiDAR is taken as the origin O, the straight line L representing the detected object is scanned at an equal interval angle Δθ, and then the continuous point cloud data Qᵢ is obtained; the length distance between the origin and each point cloud data is expressed as dᵢ, and then the slope value of the i-th point cloud data is calculated; when the slope value difference between adjacent point cloud data is less than a predetermined threshold, it is determined to be on the same straight line; otherwise, it is determined to be a mutation point and used as a feature point;
where the slope value kᵢ is expressed as:

$${k}_{i} = \frac{{d}_{i + 1} - {d}_{i}}{{d}_{i} Δ θ} .$$

In S24 of this embodiment, the least squares method is used to fit the characteristic line. For a set of two-dimensional data points (xᵢ, yᵢ), these points are fitted by finding a straight line y=mx+b, where m is the slope and b is the intercept; in this embodiment, m and b are determined by the following objective functions;

$$S = {\sum }_{i = 1}^{N} {( {y}_{i} - ( {mx}_{i} + b ) )}^{2} .$$

where S is the sum of squared errors. By setting the partial derivative of S to zero, the analytical solutions of m and b can be obtained. The equation is solved as follows:

$$\{ \begin{matrix}\frac{\partial S}{\partial m} = - 2 {\sum }_{i = 1}^{N} {x}_{i} ( {y}_{i} - {mx}_{i} - b ) = 0 \\ \frac{\partial S}{\partial m} = - 2 {\sum }_{i = 1}^{N} ( {y}_{i} - {mx}_{i} - b ) = 0\end{matrix} .$$

The objective function expression of the solution is as follows:

$$\{ \begin{matrix}m = \frac{{\sum }_{i = 1}^{N} ( {x}_{i} - \overline{x} ) ( {y}_{i} - \overline{y} )}{{\sum }_{i = 1}^{N} ( {x}_{i} - \overline{x} )} \\ b = \overline{y} = m \overline{x}\end{matrix} .$$

In S25 of this embodiment, the ICP algorithm is used to accurately register the point cloud data. The core idea of the ICP algorithm is to find the optimal rigid body transformation between the source point cloud and the target point cloud through iteration, so that the sum of the squares of the point pair distance between the two point clouds is minimized. Let the source point cloud be P={p₁, p₂, . . . , p_{N}}, and the target point cloud be Q={q₁, q₂, . . . , q_{N}}. The expression of the rigid body transformation matrix T is as follows:

$$T = [ \begin{matrix}R & t \\ 0 & 1\end{matrix} ] .$$

where R is a rotation matrix, and t is a translation vector.

The error function is defined as:

$$E ( R , t ) = {\sum }_{i = 1}^{N} {‖ {q}_{i} - ( {Rp}_{i} + t ) ‖}^{2} .$$

In S26 of this embodiment, the point cloud data of each frame after fine registration is divided into voxel grids, and the average value of each voxel is calculated; the point cloud data of different frames is aligned, and the grey wolf optimization algorithm is used to determine the optimal transformation matrix; the aligned point cloud data is voxel fused to generate a unified point cloud map.

S3 of the embodiment of the invention includes the following steps:
S31, the K-nearest neighbors search algorithm is used to search each point cloud in the point cloud data of the unified point cloud map to find the corresponding K-nearest neighbors point cloud;
S32, the principal component analysis network is used to perform a principal component analysis on the neighborhood of the searched point cloud, the covariance matrix is calculated, and the eigenvalues and eigenvectors are extracted, and then the local tangent space of each point cloud in a corresponding neighborhood is obtained;
S33, the Riemannian metric matrix of each point cloud is calculated according to the local tangent space;
S34, the multidimensional scale analysis method is used to integrate the Riemannian metric matrix of all point clouds to obtain a global parameter representation of point cloud data on the Riemannian manifold.

In S31 of this embodiment, for any high-dimensional point cloud data in the unified point cloud map, the K-nearest neighbors search algorithm is used to find the K nearest neighbors points of each point in the high-dimensional space.

In an optional embodiment, data structures such as KD tree and sphere tree can also be used to accelerate the search for adjacent point clouds.

S32 of this example is as follows:
The principal component analysis network is used to perform principal component analysis on the neighborhood of the point cloud obtained by the search. The point cloud data obtained by the analysis is decentralized, and the covariance matrix of the decentralized neighborhood point cloud data is calculated. The covariance matrix is decomposed to obtain the eigenvalues and eigenvectors, and the local tangent space of each point cloud in its field is calculated according to the eigenvalues and eigenvectors;
in the three-dimensional space where the local tangent space is located, the feature vector Vⱼ corresponds to the main direction of the local geometry, where the feature vector V₁ denotes the main direction of a point cloud data distribution, the feature vector V₂ denotes the secondary direction, and the feature vector V₃ denotes the local normal vector, that is, the normal vector of the point cloud surface; the feature vectors V₁ and V₂ form the local tangent space, and the feature vector V₃ is perpendicular to the local tangent space.

Among them, the formula for decentralizing the neighborhood point cloud is

$$\overline{{p}_{ι J}} = {p}_{ij} - \overline{{p}_{ι}} .$$

where p̅ᵢ denotes the mean value of the domain point cloud,

$$\overline{{p}_{ι}} = \frac{1}{K} {\sum }_{j = 1}^{K} {p}_{ij} .$$

The covariance matrix is expressed as

$${C}_{i} = \frac{1}{K} {\overline{p}}_{ι}^{T} {\overline{p}}_{ι} .$$

The formula for feature decomposition is Cᵢvⱼ=λᵢvⱼ, where λⱼ is the eigenvalue, vⱼ is the eigenvector, which are usually arranged.

Through the aforementioned steps, the global parameterization of high-dimensional point cloud data on a Riemannian manifold can be accomplished, thereby effectively revealing the internal structure and relationships within the data.

S4 of the embodiment of the invention includes the following steps:
S41, the Delaunay triangulation method is used to generate a triangular mesh in the manifold space where globally parameterized point cloud data is located, and a continuous three-dimensional manifold surface is generated from the triangular mesh;
S42, the topological structure of the three-dimensional manifold surface is extracted;
S43, the topological structure characteristics of the three-dimensional manifold surface are extracted by using the discrete Morse theory algorithm, and the topological structure is optimized;
S44, the optimization method of graph cuts is used to perform a smooth and curvature adjustment for the three-dimensional manifold surface according to the optimized topology;
S45, the three-dimensional visualization of the three-dimensional manifold surface is performed after the smooth and curvature adjustment to generate a local map of the current position.

In S41 of this embodiment, Delaunay triangulation is performed on the globally parameterized point cloud data in three-dimensional space to generate a triangular or tetrahedral mesh. The attributes of each triangle or tetrahedron, such as area, volume, and adjacency relationships, are calculated. A discrete Morse function f is defined, mapping each point to a real value. Based on the Delaunay triangulation, discrete Morse theory is then applied to identify critical points (extrema and saddle points) and critical lines. The Morse simplification algorithm is subsequently used to remove redundant topological structures while retaining key features, thereby obtaining the three-dimensional manifold surface.

In S44 of this embodiment, the results derived from discrete Morse theory are represented as a graph model, and the minimum cut/maximum flow algorithm is employed to solve for the optimal cut. According to the optimal cut results, an optimized triangular or tetrahedral mesh model is generated. Texture mapping is applied to the 3D model to enhance visual realism, and post-processing operations, such as smoothing and denoising, are performed to improve the overall quality of the three-dimensional map.

S5 of the embodiment of the invention includes the following steps:
S51, in the process of local map generation, the aircraft odometer data is continuously collected to obtain real-time estimated pose information and determine its corresponding current position;
S52, when the Euclidean distance between the current position and the historical position of the aircraft is less than the predetermined threshold, a loopback detection is triggered;
S53, the feature points are extracted from the collected data of a binocular camera configured for the aircraft;
S54, a feature point matching and data splicing are performed on extracted feature points in turn, and then it is fused with the point cloud data of a LiDAR in the current position;
S55, according to fused data, the pose error of the aircraft between the current frame and the historical frame is calculated, and according to the aircraft pose information after optimization and adjustment, and then the point cloud data corresponding to the optimized aircraft pose information is fused into the local map;
S56, the smooth and curvature adjustment is performed for the three-dimensional manifold surface corresponding to the local map after the fusion of point cloud data to obtain the optimized local map.

In the aforementioned steps, during loop closure detection, a reuse constraint on the global pose is imposed once the aircraft is identified as revisiting a previously traversed area. The graph optimization algorithm is then employed to perform a global optimization of these constraints. This process eliminates cumulative errors, enhances the global consistency of the map, and yields an optimized local map.

Specifically, a binocular camera is used to capture left and right images, and depth information is calculated through stereo matching. Simultaneously, a single-beam LiDAR scans the environment to acquire point cloud data. The extrinsic parameter matrix between the binocular camera and the single-beam LiDAR is obtained via calibration, enabling the conversion between the two coordinate systems. The depth information from the binocular camera is fused with the point cloud data from the LiDAR, and the Kalman filter algorithm is applied to achieve precise alignment. Through weighted averaging or other fusion methods, the depth information and point cloud are integrated to generate a high-precision 3D model.

Based on the updated pose and new sensor data, the multi-perspective maps are updated and fused to produce a more accurate panoramic map. Finally, the optimized panoramic map is displayed and stored in real time for subsequent analysis and use. The entire process ensures that the aircraft can construct a high-precision, globally consistent panoramic map in unknown or dynamic environments.

S6 of the embodiment of the invention includes the following steps:
S61, the boundary of the unexplored area in the current optimized local map is detected, and a target point closest to the aircraft is selected;
S62, the A* path planning algorithm is used to calculate the optimal path from a current boundary point to the target point;
S63, a uniform sampling is performed for the determined optimal path, the selected control points, curve orders, and node vectors are used to calculate a B-spline basis function, and then a B-spline curve is subdivided into several discrete points as the passing points of the aircraft;
S64, S1-S5 are performed to gradually generate the optimized local map at each passing point, and then the unknown environment mapping is completed.

Specifically, in the process above, environmental data is collected by sensors, and maps are constructed and updated in real time to identify known areas, unknown areas, and obstacles. First, the starting point and target point of the aircraft are determined. Next, a frontier search algorithm is used to detect the boundary between known and unknown regions, generating a set of frontier points. These frontier points represent new areas for exploration and guide the aircraft's search expansion. Then, starting from the current position, the A* algorithm is employed to plan a path within the known map, finding the optimal route from the starting point to the target point. By combining the actual path cost with a heuristic function, the A* algorithm ensures both the efficiency and reliability of the planned path. After the path is generated, it undergoes smoothing and optimization, taking into account the aircraft's motion constraints and environmental characteristics to ensure practical feasibility. Finally, the control system drives the aircraft to follow the optimized path. During execution, dynamic obstacle avoidance and path adjustments are performed to respond to real-time environmental changes, ensuring the aircraft reaches the target point safely.

In S63 of this embodiment, under a selected set of control points {p₀, p₁, . . . , pₙ}, the B-spline curve is represented as:

$$C ( t ) = {\sum }_{n = 0}^{N} {N}_{n , k} ( t ) {P}_{n} .$$

where C(t) denotes the point of the B-spline curve at a parameter t, Pₙ denotes the n-th control point, and N_{n,k}(t) denotes the k-th-order B-spline basis function corresponding to a n-th control point, it is expressed as:

$${N}_{n , k} ( t ) = \frac{t - {t}_{n}}{{t}_{n + k} - {t}_{n}} {N}_{n , k - 1} ( t ) + \frac{{t}_{n + k + 1} - t}{{t}_{n + k + 1} - {t}_{n + 1}} {N}_{n + 1 , k - 1} ( t )$$

where tₙ denotes the n-th node value in the spline knot vector.

In this invention, based on the preceding stepwise description, the data collected by a single-beam LiDAR is first timestamp-synchronized with the stepper motor. The acquired point cloud data is then filtered and matched to derive three-dimensional map information. The pose of the aircraft is estimated using wheel odometry and an IMU, and loop closure detection is performed to reduce cumulative error, thereby updating the 3D map information in real time. A frontier search algorithm is employed to determine the target point for the aircraft's flight, the A* algorithm is used to plan the path trajectory, and a B-spline curve optimization algorithm is applied to smooth the trajectory, the control commands are subsequently sent to the aircraft.

The principles and implementation methods of the invention are expounded through specific embodiments provided herein. These examples are intended solely to aid in understanding the method and core concepts of the invention. At the same time, it should be noted that for those skilled in the art, variations in specific implementation details and scope of application may arise according to the inventive concept. In summary, the content of this description shall not be construed as limiting the invention.

Those skilled in the art will appreciate that the embodiments described here are intended to assist readers in understanding the principles of the invention, and it should be understood that the scope of protection of the invention is not limited to such specific statements and examples. Based on the technical disclosures provided by the invention, skilled practitioners may make various other modifications and combinations without departing from its essence, and such modifications and combinations shall remain within the protection scope of the invention.

What is claimed is:

1. An unknown environment mapping method for an aircraft single-beam laser, wherein the aircraft is configured with a single-beam laser detection and ranging (LiDAR), a stepper motor, and a binocular camera, and wherein point cloud data of the single-beam LiDAR is aligned with stepper motor data on a timestamp;
wherein the method comprises the following steps:
S1, denoising point cloud data collected at a current position, and adjusting position and attitude information of an aircraft by using denoised point cloud data, so as to unify a single-beam LiDAR coordinate system and the aircraft;
S2, based on a unified coordinate system, aligning the point cloud data at adjacent positions initially, and performing a feature extraction, a point cloud alignment and a point cloud stitching in turn to generate a unified point cloud map;
S3, for point cloud data in the unified point cloud map, establishing a local neighborhood of each point cloud according to a K-nearest neighbors search algorithm, and determining a local tangent space of each point cloud in a local neighborhood by a principal component analysis method, using a multi-dimensional scaling analysis method to integrate information of all local tangent spaces, and obtaining a global parameterization of the point cloud data on a Riemannian manifold;
S4, based on point cloud data represented by the global parameterization, generating a continuous three-dimensional manifold surface according to a Delaunay triangulation method, and generating a local map of the current position after a smooth and curvature adjustment of the continuous three-dimensional manifold surface;
S5, in a process of aircraft data acquisition, using a loop detection algorithm to correct a pose of the aircraft, and then optimizing a local map to obtain an optimized local map; and
S6, taking a current optimized local map as a starting point, performing a boundary exploration and a path planning, and collecting data according to a planned path, repeating S1-S5 to gradually generate an optimized local map, and then completing an unknown environment mapping.

2. The unknown environment mapping method for the aircraft single-beam laser according to claim 1, wherein S1 comprises the following steps:
S11, calculating a distance between the point cloud data collected at the current position and its adjacent point cloud;
S12, according to an average value and standard deviation of each distance, determining a determination threshold of an outlier point cloud;
S13, removing outlier point cloud data according to the determination threshold of the outlier point cloud, and completing a point cloud noise reduction;
S14, extracting feature points from the point cloud data after a noise reduction;
S15, according to a type of feature points and a nearest point search method, establishing a geometric relationship between feature points after noise reduction at different times, and then calculating a pose estimation of a single-beam LiDAR during this period;
S16, according to an estimated pose estimation, using the point cloud data from different perspectives for three-dimensional reconstruction, and then determining an initial pose of the aircraft;
S17, according to the initial pose of the aircraft, using a Kalman-based fusion matching algorithm to predict a next state estimation of the aircraft, and correcting the state estimation according to a difference between a predicted value and an actual observed value to obtain a next pose of the aircraft;
S18, weighting and averaging the initial pose and the next pose of the aircraft to adjust the attitude information of the aircraft, and then unifying a single-beam LiDAR coordinate system of the aircraft.

3. The unknown environment mapping method for the aircraft single-beam laser according to claim 1, wherein S2 comprises the following steps:
S21, according to a random sampling consistency algorithm, using a registration point to unify a coordinate system of two points to be configured in the point cloud data at adjacent positions, and completing an initial alignment to obtain coarsely calibrated point cloud data;
S22, clustering continuous point cloud data collected by a single-beam LiDAR to extract feature points;
wherein types of feature points include scatter points, corner points, and breakpoints;
S23, using an improved iterative adaptive point algorithm to screen the corner points, using a continuous edge tracking algorithm to screen the breakpoints, and then screening out all the real corner points and breakpoints, and filtering out scattered points;
S24, using a least square method to perform a feature line fitting of selected corner points and breakpoints to determine a feature line segment;
S25, using an ICP algorithm to coarsely calibrate point cloud data and feature line segments for fine registration; and
S26, fusing finely registered point cloud data into a unified voxel grid, and performing a point cloud stitching to generate a unified point cloud map.

4. The unknown environment mapping method for the aircraft single-beam laser according to claim 3, wherein in S22, the method of clustering continuous point cloud data is as follows:
taking a position of a single-beam LiDAR as an origin O, scanning a straight line L representing a detected object at an equal interval angle Δθ, and then obtaining a continuous point cloud data Qᵢ; a length distance between the origin and each point cloud data is expressed as dᵢ, and then calculating a slope value of an i-th point cloud data; when a slope value difference between adjacent point cloud data is less than a predetermined threshold, it is determined to be on the same straight line; otherwise, it is determined to be a mutation point and used as a feature point;
where a slope value kᵢ is expressed as:
$${k}_{i} = \frac{{d}_{i + 1} - {d}_{i}}{{d}_{i} Δ θ} .$$

5. The unknown environment mapping method for the aircraft single-beam laser according to claim 1, wherein S3 comprises the following steps:
S31, using the K-nearest neighbors search algorithm to search each point cloud in the point cloud data of the unified point cloud map to find a corresponding K-nearest neighbors point cloud;
S32, using a principal component analysis network to perform a principal component analysis on a neighborhood of a searched point cloud, calculating a covariance matrix and extracting eigenvalues and eigenvectors, and then obtaining a local tangent space of each point cloud in a corresponding neighborhood;
S33, calculating a Riemannian metric matrix of each point cloud according to the local tangent space; and
S34, using a multidimensional scale analysis method to integrate the Riemannian metric matrix of all point clouds to obtain a global parameter representation of point cloud data on the Riemannian manifold.

6. The unknown environment mapping method for the aircraft single-beam laser according to claim 5, wherein S32 is specified as follows:
using a principal component analysis network to perform a principal component analysis on the neighborhood of the point cloud obtained by searching; decentralizing point cloud data obtained by analysis, and calculating a covariance matrix of decentralized neighborhood point cloud data; decomposing the covariance matrix to obtain the eigenvalues and eigenvectors, and calculating the local tangent space of each point cloud in its field according to the eigenvalues and eigenvectors; and
in a three-dimensional space where the local tangent space is located, a feature vector Vⱼ corresponds to a main direction of a local geometry, where a feature vector V₁ denotes a main direction of a point cloud data distribution, a feature vector V₂ denotes a secondary direction, and a feature vector V₃ denotes a local normal vector, that is, a normal vector of the point cloud surface; the feature vectors V₁ and V₂ form the local tangent space, and the feature vector V₃ is perpendicular to the local tangent space.

7. The unknown environment mapping method for the aircraft single-beam laser according to claim 1, wherein S4 comprises the following steps:
S41, using the Delaunay triangulation method to generate a triangular mesh in a manifold space where globally parameterized point cloud data is located, and generating a continuous three-dimensional manifold surface from the triangular mesh;
S42, extracting a topological structure of the three-dimensional manifold surface;
S43, extracting topological structure characteristics of the three-dimensional manifold surface by using a discrete Morse theory algorithm, and optimizing the topological structure;
S44, using an optimization method of graph cuts to perform a smooth and curvature adjustment for the three-dimensional manifold surface according to an optimized topology; and
S45, performing a three-dimensional visualization of the three-dimensional manifold surface after the smooth and curvature adjustment to generate a local map of a current position.

8. The unknown environment mapping method for the aircraft single-beam laser according to claim 1, wherein S5 comprises the following steps:
S51, in a process of local map generation, collecting aircraft odometer data continuously to obtain real-time estimated pose information and determine a corresponding current position;
S52, when an Euclidean distance between the current position and a historical position of the aircraft is less than the predetermined threshold, a loopback detection is triggered;
S53, extracting feature points from collected data of a binocular camera configured for the aircraft;
S54, performing a feature point matching and data splicing on extracted feature points in turn, and then fusing with the point cloud data of a LiDAR in the current position;
S55, according to fused data, calculating a pose error of the aircraft between a current frame and a historical frame, and according to aircraft pose information after optimization and adjustment, and then fusing the point cloud data corresponding to the optimized aircraft pose information into the local map; and
S56, performing a smooth and curvature adjustment of the three-dimensional manifold surface corresponding to the local map after a fusion of point cloud data to obtain an optimized local map.

9. The unknown environment mapping method for the aircraft single-beam laser according to claim 1, wherein S6 comprises the following steps:
S61, detecting a boundary of an unexplored area in the current optimized local map, and selecting a target point closest to the aircraft;
S62, using an A* path planning algorithm to calculate an optimal path from a current boundary point to the target point;
S63, performing a uniform sampling for the determined optimal path, using selected control points, curve orders, and node vectors to calculate a B-spline basis function, and then subdividing a B-spline curve into several discrete points as passing points of the aircraft;
S64, performing S1-S5 to gradually generate an optimized local map at each passing point, and then completing an unknown environment mapping.

10. The unknown environment mapping method for the aircraft single-beam laser according to claim 1, wherein in S63, under a selected set of control points {p₀, p₁, . . . , pₙ}, the B-spline curve is represented as:
$$C ( T ) = {\sum }_{n = 0}^{N} {N}_{n , k} ( t ) {P}_{n}$$
where C(t) denotes a point of the B-spline curve at a parameter t, Pₙ denotes an n-th control point, and N_{n,k} (t) denotes a k-th-order B-spline basis function corresponding to an n-th control point, it is expressed as:
$${N}_{n , k} ( t ) = \frac{t - {t}_{n}}{{t}_{n + k} - {t}_{n}} {N}_{n , k - 1} ( t ) + \frac{{t}_{n + k + 1} - t}{{t}_{n + k + 1} - {t}_{n + 1}} {N}_{n + 1 , k - 1} ( t ) ;$$
where tₙ denotes the n-th node value in the spline knot vector.
